(19) United States
(12) Patent Application Publication
(10) Pub. No.: US 2007/0037078 A1
(43) Pub. Date: Feb. 15, 2007

(54) REFERENCE WAFER FOR CALIBRATING SEMICONDUCTOR EQUIPMENT

(75) Inventors: Kun-Gu LEE, Seoul (KR); Ki-Ho SEONG, Gyeonggi-do (KR); Yoo-Mi LEE, Seoul (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-Do (KR)

(21) Appl. No.: 11/463,826

(22) Filed: Aug. 10, 2006

(30) Foreign Application Priority Data
Aug. 11, 2005 (KR) 2005-0073728

(51) Int. Cl. G03C 5/00

(52) U.S. Cl. 430/30

(57) ABSTRACT

A reference wafer for calibrating a laser and a camera and checking laser accuracy and spot size. The reference wafer may include a light absorption layer on a semiconductor substrate and a light reflection layer pattern on the light absorption layer. The light reflection layer pattern may include a first pattern for checking the laser accuracy and spot size and a second pattern for calibrating the laser and camera. A first anti-reflective layer may be introduced between the light absorption layer and the semiconductor substrate, and a second anti-reflective layer may be introduced between the light absorption layer and the light reflection layer pattern.

### CROSS-REFERENCE TO RELATED PATENT APPLICATION

This application claims the benefit of Korean Patent Application No. 10-2005-0073728, filed on Aug. 11, 2005, in the Korean Intellectual Property Office, the disclosure of which is incorporated herein in its entirety by reference.

### BACKGROUND

1. Field of the Invention

The present invention relates to semiconductor equipment, and more particularly, to a reference wafer for calibrating a laser and a camera and checking laser accuracy for the semiconductor equipment.

2. Description of the Related Art

As the integration of a semiconductor element increases, its design rules becomes tighter. Accordingly, more accurate control is required with respect to semiconductor equipment used in a process of manufacturing the semiconductor device. Specifically, in the semiconductor equipment where a laser is used, its control and accuracy and its spot size become more important with the tighter design rules. For example, fuse repair equipment uses a focused laser for fuse cutting, and the thin film measurement system uses a laser to measure the reflectivity or refractive index of the thin film.

Korean Patent Laid-Open Publication No. 2002-0086760, filed in the name of Jae-Dong KIM, discloses a reference wafer for calibration, and a method for calibrating an apparatus for thickness measurements of semiconductor layers using the reference wafer. The disclosed reference wafer is capable of reducing times required for measuring the thicknesses of each layer and the total thickness of the semiconductor device, which comprises a number of thin film layers.

However, Jae-Dong KIM provides the reference wafer with respect to the thin film layer structure only and does not provide any general reference wafer for calibrating a laser.

During extended periods of using semiconductor equipment, its laser accuracy and alignment of spot size may deteriorate due to cleaning, maintenance, and repair work. Moreover, in semiconductor equipment where a camera is utilized to align or check the semiconductor substrate, the camera may become misaligned. Thus, it is necessary to periodically check the laser accuracy and to recalibrate the laser and camera.

Calibrating the laser and camera, checking the laser accuracy, and checking alignment of the spot size have been separately performed by using an applicable calibration implement or grid. Consequently, a number of calibration implements or grids must be provided, thereby consuming time and cost.

### SUMMARY

Embodiments provide a reference wafer for calibrating a laser and a camera and checking laser accuracy and spot size.

According to an embodiment, for example, a reference wafer for calibrating semiconductor equipment comprises a semiconductor substrate; an anti-reflective layer on the semiconductor substrate; a light absorption layer absorbing laser light, formed on the anti-reflective layer; and a light reflection layer pattern arranged on the light absorption layer and formed of a light reflection layer, including a first pattern for checking laser accuracy and spot size and a second pattern for calibrating a laser and a camera.

In another embodiment, another anti-reflective layer may be formed on the light absorption layer.

According to yet another embodiment, for example, a reference wafer for calibrating semiconductor equipment comprises a semiconductor substrate; a first anti-reflective layer on the semiconductor substrate; a light absorption layer absorbing laser light, formed on the first anti-reflective layer; a first adhesive layer introduced between the first anti-reflective layer and the light absorption layer; a second anti-reflective layer on the light absorption layer; a light reflection layer pattern arranged on the second anti-reflective layer, including a first pattern for checking laser accuracy and spot size and a second pattern for calibrating a laser and a camera; and a second adhesive layer introduced between the second anti-reflective layer and the light reflection layer pattern.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view illustrating a reference wafer according to an embodiment;

FIG. 2 is a cross-sectional view illustrating a reference wafer according to another embodiment;

FIG. 3 is a plan view illustrating a light reflection layer pattern of the reference wafer according to the embodiments;

FIG. 4 is a schematic view illustrating a laser waveform scanning an image of the reference wafer according to the embodiments;

FIG. 5 is a graph illustrating reflectivity of the reference wafer of FIG. 1 through path A according to the thickness of a tungsten layer;

FIG. 6 is a graph illustrating reflectivity of the reference wafer of FIG. 1 through path B according to the thickness of an Al layer; and

FIG. 7 is a graph illustrating reflectivity of the reference wafer of FIG. 2 through path B according to the thickness of an Al layer.

### DETAILED DESCRIPTION

The present invention will now be described more fully hereinafter with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art. For the convenience of clarification, elements in the drawings may be overstated with respect to their size.

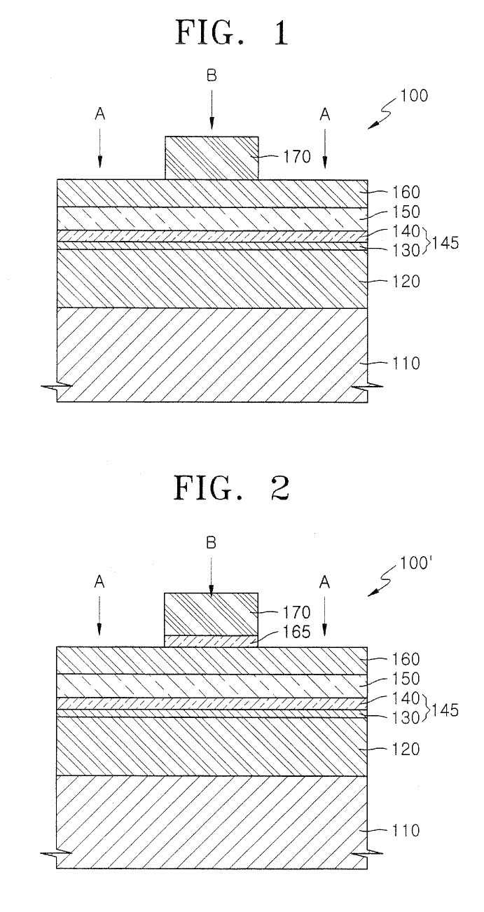

FIG. 1 is a cross-sectional view illustrating a reference wafer 100 according to an embodiment. The reference wafer 100 may be used for checking the accuracy of a laser or the alignment of a spot size and calibrating the laser in the semiconductor equipment. Further, the reference wafer 100 may be used for calibrating a camera of the semiconductor equipment. For example, semiconductor equipment may be for fuse repairing or thin film thickness measuring. Nevertheless, the reference wafer 100 may be used for any semiconductor equipment where a laser is used.

With reference to FIG. 1, the reference wafer 100 comprises a light absorption layer 150 on a semiconductor substrate 110, and a light reflection layer pattern 170 on the light absorption layer 150. A first anti-reflective layer 120 is introduced between the light absorption layer 150 and the semiconductor substrate 110, and a second anti-reflective layer 160 is introduced between the light absorption layer 150 and the light reflection layer pattern 170. Additionally, a first adhesive layer 145 may be introduced between the light absorption layer 150 and the first anti-reflective layer 120.

More specifically, the semiconductor substrate 110 may be opaque. For example, the semiconductor substrate 110 may be silicon or silicon-germanium. The semiconductor substrate 110 may have an 8 or 12 inch diameter. However, the size of the semiconductor substrate 110 does not limit the scope of the present invention and may be appropriately selected by a person skilled in this art.

The first and second anti-reflective layers 120 and 160 prevent the reflection of laser light and help transmit it to the underlying absorbing layers. For example, the first and second anti-reflective layers 120 and 160 may comprise a silicon oxide (SiO₂) layer, respectively. As a more specific example, the first anti-reflective layer 120 may be a SiO₂ layer with a thickness of about 3500 Å to about 4500 Å, and the second anti-reflective layer 160 may be a SiO₂ layer with a thickness of about 1500 Å to about 2100 Å.

The first anti-reflective layer 120 contributes to an overall efficiency of preventing the light that is transmitted through the light absorbing layer 150 from reflecting off the substrate 110. By the time the light reaches the substrate 110, it will be diminished to an insignificant amount. In an embodiment, the first anti-reflective layer 120 may not be included.

The light absorption layer 150 is capable of absorbing the laser light that penetrates the second anti-reflective layer 160. Accordingly, low reflectivity of the light absorption layer 150 is preferred, e.g., it may be less than 70%. For example, the light absorption layer 150 may comprise a tungsten layer of which the reflectivity is less than 60%. The thickness of the light absorption layer 150 may be selected with a consideration for the reflectivity and potential warping from any internal stresses.

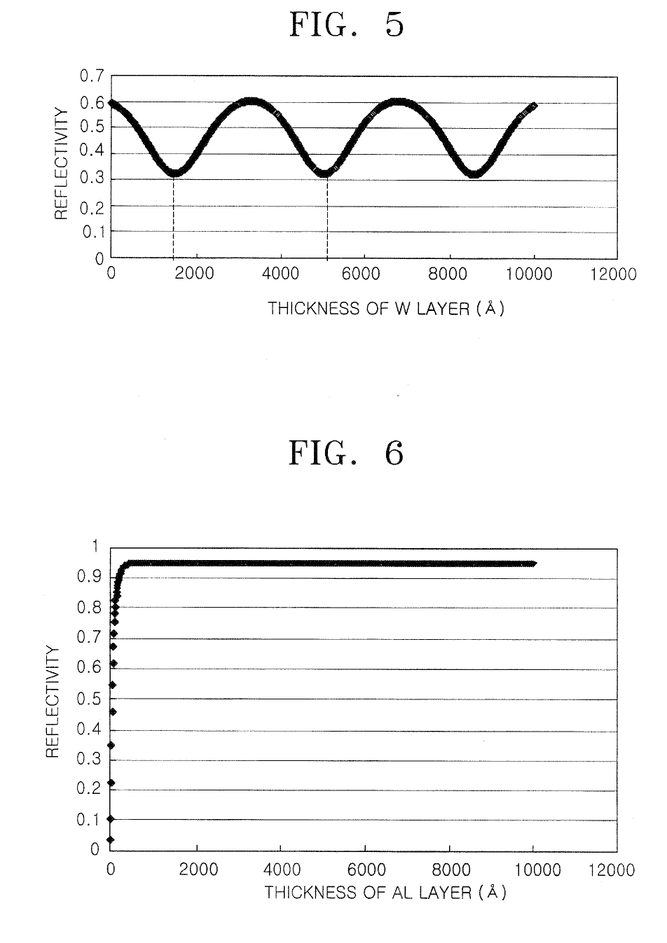

FIG. 5 illustrates the reflectivity of the reference wafer 100 through path A according to the thickness of the light absorption layer 150, which in this case is a tungsten layer. Path A represents a path where the laser passes through the second anti-reflective layer 160 portion that is not covered by the light reflection pattern 170.

With reference to FIG. 5, the reflectivity according to a change in the thickness of the tungsten layer shows a regular waveform, as one skilled in the art well knows from thin film interference studies. The reflectivity has a low value when the thickness of the tungsten layer is about 1500 Å or 5000 Å. Consequently, the thickness of the light absorption layer 150 formed of the tungsten layer may be about 1500 Å or 5000 Å. In consideration of the influence and margin of other layers, the thickness of the light absorption layer 150 may be in the range of about 1350 Å to about 1650 Å or about 4500 Å to about 5500 Å.

However, the tungsten layer may experience a stress on the reference wafer 100 since it contracts after deposition. When the stress is excessive, warping may occur to the reference wafer 100 by the contraction of the tungsten layer. With warping, it is difficult for the light reflection layer pattern 170 to form on the tungsten layer. Focus may change according to a position of the reference wafer 100 in a photolithography process to form the light reflection laser pattern 170. Thus, it is desirable that the thickness of the light absorption layer 150 is within the range of about 1350 Å to about 1650 Å, in consideration of both reflectivity and warpage.

Consequently, with reference to FIGS. 1 and 5, it is possible to prevent the reference wafer 100 from warping and to reduce the reflectivity of the laser light through path A by selecting the light absorption layer 150 having the appropriate thickness.

Again, with reference to FIG. 1, the first adhesive layer 145 increases the adhesive strength between the first anti-reflective layer 120 and the light absorption layer 150. For example, the first adhesive layer 145 may comprise a lower titanium (Ti) layer 130 and an upper titanium nitride (TiN) layer 140. The lower Ti layer 130 is capable of performing as an adhesive layer between the TiN layer 140 and the first anti-reflective layer 120, and the TiN layer 140 is also capable of performing as an adhesive layer between the Ti layer 130 and the light absorption layer 150. When the light absorption layer 150 is the tungsten layer, it is known that the first adhesive layer 145 comprising the Ti layer 130 and the TiN layer 140 is capable of providing good adhesive strength between the tungsten layer an the first anti-reflective layer 120.

The TiN layer 140 may have a thickness of about 150 Å to about 250 Å, and the Ti layer 130 may have a thickness of about 50 Å to about 100 Å. The thickness of the Ti layer 130 and the TiN layer 140 may have the maximum thickness in consideration of the reflectivity and the minimum thickness to provide appropriate adhesive strength.

The light reflection layer pattern 170 is capable of reflecting incident laser light through path B. The light reflection layer pattern 170 may comprise a metal layer that is capable of reflecting more than 90% of the incident light. For a more specific example, the light reflection layer pattern 170 may comprise an aluminum (Al) layer. The thickness of the light reflection layer pattern 170 may be determined in consideration of the reflectivity. The light reflection layer pattern 170 including the Al layer will be described in an example below.

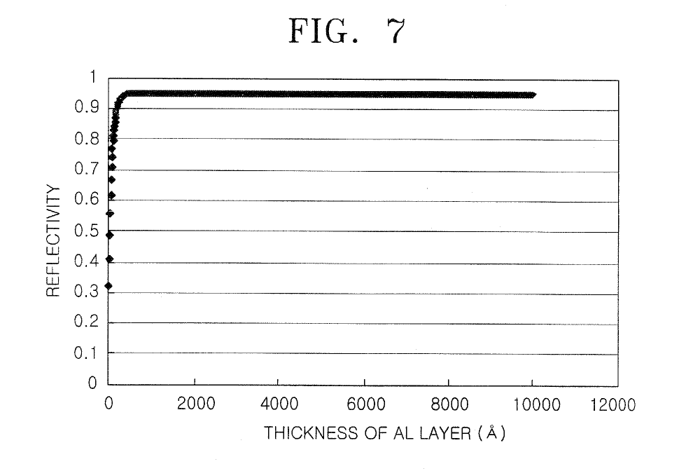

FIG. 7 illustrates the reflectivity of the reference wafer 100 through path B according to the thickness of the Al layer. Path B is a path where the laser passes through the light reflection layer pattern 170 portion covering the second anti-reflective layer 160.

With reference to FIG. 7, the reflectivity is more than 95% when the thickness of the Al layer is more than about 1000 Å. Thus, the thickness of the light reflection layer pattern 170 may be more than about 1000 Å, e.g., within the range of about 3000 Å to about 5000 Å.

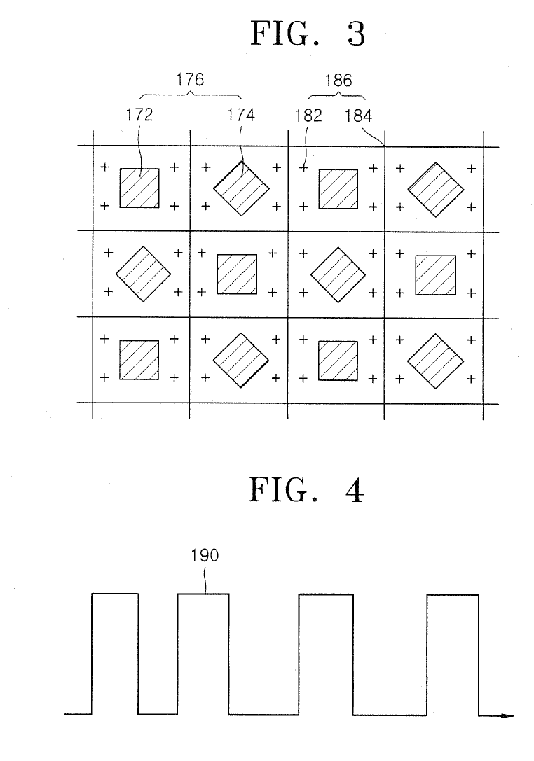

With reference to FIG. 3, a planar shape of the light reflection layer pattern 170 of the reference wafer 100 will be described. The light reflection layer pattern 170 may comprise a test pattern 176 and a grid pattern 186. The test pattern 176 may be used for checking laser accuracy, and the grid pattern 186 may be used for calibrating a laser and a camera. However, for a check of the laser accuracy, the test pattern 176 and the grid pattern 186 may be used together. Further, for the calibration of the laser, the test pattern 176 in addition to the grid pattern 186 may be used.

The test pattern 176 may comprise at least one or more kinds of polygonal patterns, e.g., it may comprise a quadrilateral pattern 172 and a diamond-shaped pattern 174. The quadrilateral pattern 172 and the diamond-shaped pattern 174 may be alternately arranged. As the quadrilateral pattern 172 and the diamond-shaped pattern 174 are exemplary, the test pattern 176 may be formed in various patterns capable of checking the laser accuracy.

The test pattern 176 may form a waveform 190 as illustrated in FIG. 4, when a laser light scan test is in process. The vertical axis represents reflectivity. The test of the laser accuracy is repeatedly performed by changing direction, and in this case, it is possible to check the laser accuracy by comparing the waveforms 190.

The grid pattern 186 may comprise a cross pattern 182 formed at four portions in the outer block of the test pattern 176 and a net pattern 184 enclosing the test pattern 176. For example, the net pattern 184 may be used for a primary calibration of the camera or laser, and the cross pattern 182 may be used for more accurate calibration.

Therefore, the check of the laser accuracy and the calibration of the laser and camera, which are performed by separate implements in the conventional art, can be performed by a single reference wafer 100 (FIG. 1) comprising the test pattern 176 and the grid pattern 186. Accordingly, costs of manufacturing and maintaining separate implements can be reduced.

FIG. 2 is a cross-sectional view illustrating a reference wafer 100′ according to another embodiment of the present invention. This embodiment is an example of a variation of the above-described embodiment of FIG. 1. Thus the description of the reference wafer 100 of FIG. 1 can be referred to as a comparison. Same reference numbers will denote same or similar elements.

With reference to FIG. 2, the reference wafer 100′ comprises similar layers as the first-described embodiment, but with the addition of a second adhesive layer 165 between the light reflection layer pattern 170 and the second anti-reflective layer 160. The second adhesive layer 165 is to increase the adhesive strength between the light reflection layer pattern 170 and the second anti-reflective layer 160. For example, the second adhesive layer 165 may comprise titanium nitride (TiN). Accordingly, it is possible to prevent the light reflection layer pattern 170 from lifting, which could contaminate the manufacturing line.

The second adhesive layer 165 may have a thickness of about 150 Å to about 250 Å. The thickness of the second adhesive layer 165 may have the maximum thickness in consideration of the reflectivity and it may have the minimum thickness to provide the appropriate adhesive strength. As an example, the light reflection layer 170 formed of the Al layer and the second adhesive layer 165 formed of the TiN layer having a thickness of 200 Å are preferred.

FIG. 6 illustrates the reflectivity of the reference wafer 100′ (FIG. 2) through path B when the TiN layer is introduced between the Al layer and the second anti-reflective layer 160.

With reference to FIG. 6, when the Al layer is more than about 1000 Å, it is noted that it is possible to achieve a reflectivity of more than 95%. Further, comparing FIG. 6 with FIG. 7, it is known that the second adhesive layer 165 formed of the TiN layer has almost no effect on the reflectivity. This is because most of the incident laser light is reflected by the Al layer.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A reference wafer for calibrating semiconductor manufacturing equipment, the reference wafer comprising:
a semiconductor substrate;
a light absorption layer on the semiconductor substrate;
an anti-reflective layer on the light absorption layer; and
a light reflection layer pattern on the anti-reflective layer, including a first pattern having relatively high reflectivity surrounded by regions of relatively low reflectivity, and a second pattern having predetermined geometric shapes.

2. The reference wafer of claim 15 further comprising another anti-reflective layer between the semiconductor substrate and the light absorption layer;

3. The reference wafer of claim 1, wherein the first pattern comprises at least one or more polygonal patterns, and the second pattern comprises at least one or more sizes of grid patterns.

4. The reference wafer of claim 3, wherein the first pattern comprises a quadrilateral pattern and a diamond-shaped pattern.

5. The reference wafer of claim 2, further comprising an adhesive layer introduced between the other anti-reflective layer and the light absorption layer.

6. The reference wafer of claim 1, wherein the light absorption layer comprises tungsten.

7. The reference wafer of claim 6, wherein the light absorption layer has a thickness of about 1350 Å to about 1650 Å.

8. The reference wafer of claim 5, wherein the adhesive layer comprises titanium and titanium nitride.

9. The reference wafer of claim 1, wherein the light reflection layer pattern comprises aluminum.

10. The reference wafer of claim 2, wherein the anti-reflective layer and the other anti-reflective layer comprise silicon oxide.

11. A reference wafer comprising:
a semiconductor substrate;
a first anti-reflective layer on the semiconductor substrate;
a light absorption layer on the First anti-reflective layer;
a first adhesive layer between the first anti-reflective layer and the light absorption layer;
a second anti-reflective layer on the light absorption layer;
a light reflection layer pattern on the second anti-reflective layer, including a first test pattern for checking laser accuracy and spot size and a second test pattern for calibrating a laser and a camera; and
a second adhesive layer introduced between the second anti-reflective layer and the light reflection layer pattern.

12. The reference water of claim 11, wherein the first test pattern comprises at least one or more polygonal patterns, and the second test pattern comprises at least one or more sizes of grid patterns.

13. The reference wafer of claim 12, wherein the first test pattern comprises a quadrilateral pattern and a diamond-shaped pattern.

14. The reference wafer of claim 11, wherein the light absorption layer comprises tungsten.

15. The reference wafer of claim 14, wherein the light absorption layer has a thickness of about 1350 Å to about 1650 Å.

16. The reference wafer of claim 11, wherein the first and second adhesive layers each comprise a titanium nitride layer.

17. The reference wafer of claim 16, wherein the titanium nitride layer has a thickness of about 150 Å to about 250 Å.

18. The reference wafer of claim 16, wherein the first adhesive layer further comprises titanium.

19. The reference wafer of claim 11, wherein the light reflection layer pattern comprises aluminum.

20. The reference wafer of claim 11, wherein the first and second anti-reflective layers comprise silicon oxide.
